(19) United States
(12) Patent Application Publication
(10) Pub. No.: US 2003/0136232 A1
(43) Pub. Date: Jul. 24, 2003

(54) Ratchet wrench with cambered concave portions

(76) Inventor: Chih-Ming Chang, Chung Hua (TW)

Correspondence Address: Chih-Ming Chang, 235 Chung-Ho, Box 8-24, Taipei, TW

(21) Appl. No.: 10/336,679

(22) Filed: Jan. 6, 2003

Related U.S. Application Data
(63) Continuation-in-part of application No. 09/670,567, filed on Sep. 27, 2000.

(51) Int. Cl. B25B 13/46

(52) U.S. Cl. 81/60

(57) ABSTRACT

A ratchet wrench comprises a ratchet and a ratchet base. The ratchet base has a ratchet positioning hole for positioning the ratchet gear. A recess is formed in an inner wall of the ratchet base and hidden inside a gap where the ratchet base and a handle are connected. The recess is formed with a predetermined shape and a positioning base is placed in the recess. The positioning base has a shape suitable for being placed in the recess. A plurality of cambered concave portions are formed in the positioning base for receiving mechanical members and elastic members such that the mechanical member is directly restricted by the cambered concave portion. A fixing rod is installed at the positioning base at a side without the cambered concave portions, and a fixing hole is formed in a wall of the recess. The fixing rod is inserted into the fixing hole.

The present invention is a continuation in part (CIP) of U.S. patent application Ser. No. 09/670,567, assigned to the inventor of the present invention. The contents of the specification of the filing patent is incorporated into the present invention as a part of the invention.

### BACKGROUND OF THE INVENTION

1. Field of the Invention

The present invention relates to ratchet wrenches, more particularly to a ratchet wrench having a positioning base with a plurality of cambered concave portions for receiving a plurality of mechanical members and elastic members.

2. Description of the Prior Art

In U.S. Pat. No. 1,307,485, entitled “Torque Wrench”, a wrench is disclosed. The wrench has three pawls 19, 20, and 21 which are installed inside a cambered concave portion 17 on a handle 18 near a head 10 of the wrench, and the three pawls are pushed by three springs 25 which are mounted by pivot pins 22, 23, 24 and hubs 14, 15. The springs 25 are extended and arranged by a working tool and then are placed into the head 10 of the wrench such that the three pawls 19, 20, 21 mechanically rotate the ratchet 11 through an angle. A collar is installed on the upper section of the head 10 of the wrench, and placed in the hub 15 for restricting the ratchet 11 in the interior of the head 10 and preventing it from falling off. However, such structure at least has the following defects:

1. Each pawl must have a spring, and the pivot pin passes through the pawl and spring. Then they are mounted at the bottom of the wrench head. The alignment in assembly is difficult and takes much time, and the pivot pins are exposed out from the head of the wrench. This will damage the overall appearance of the wrench.

2. The holes for mounting the pivot pins must have a higher precision. Because of the demand of high precision, it increases the difficulty in manufacturing work.

3. Since the pawl is coupled to the pivot pin, when the pawls and the ratchet are not mechanically matched to each other, the load of the pivot pin is obviously not enough. When a large torque is applied to the wrench, it may cause the pivot pins to be damaged and as a result, the pawls will fall down.

4. The gears of the ratchet are transversally deposed. When the pawls and the ratchet are not matched with one another, and is operated with a large torque applied thereon, the size of the wrench head is restricted to a size as small as possible in order to fulfill the requirement of operating in a very small space. As the size of the ratchet is reduced relatively, its thickness also reduces, and its strength is weakened, so that the ratchet may crack very easily.

### SUMMARY OF THE INVENTION

Therefore, the primary object of the present invention is to provide an improved structure of a ratchet wrench, wherein an recess is deposed at the position where the handle is coupled to the internal rim of the ratchet positioning hole, and a plurality of cambered concave portions are formed within the recess. At least one mechanical member and one elastic member are arranged in the recess such that the mechanical member is restricted and positioned directly by each cambered concave portion. In addition, a ratchet base has a protruding edge, and one end thereof is slightly larger than the external diameter of the ratchet, and the other end of the ratchet having a spanning base. Its outer diameter is slightly smaller than the inner diameter of the protruding rim of said ratchet base. The ratchet has a ring-like groove for positioning a C-ring.

Another further objective of the present invention is to provide a ratchet wrench; wherein each cambered concave portion has a blocking wall for pressing a mechanical member by an elastic member along the excircle of the ratchet in order to reduce the resistance of the ratchet.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows a perspective view of the parts of a first preferred embodiment of the present invention.

FIG. 2 shows a plane perspective view showing the assembly of the first preferred embodiment of the present invention.

FIG. 3 is a plane perspective view showing the assembly of a second preferred embodiment of the present invention.

FIG. 4 is a perspective view of the parts of a third preferred embodiment of the present invention.

FIG. 5 shows a plane perspective view showing the assembly of the third preferred embodiment of the present invention.

FIG. 6 is a perspective view showing the parts of a fourth preferred embodiment of the present invention.

FIG. 7 is a perspective view showing the assembly of a fourth preferred embodiment of the present invention.

FIG. 8 is a cross-sectional view showing the assembly of the ratchet and the ratchet base according to the present invention.

FIG. 9 is a cross-sectional view of the assembly of the ordinary ratchet and ratchet base used in the present invention.

### DESCRIPTION OF THE PREFERRED EMBODIMENT

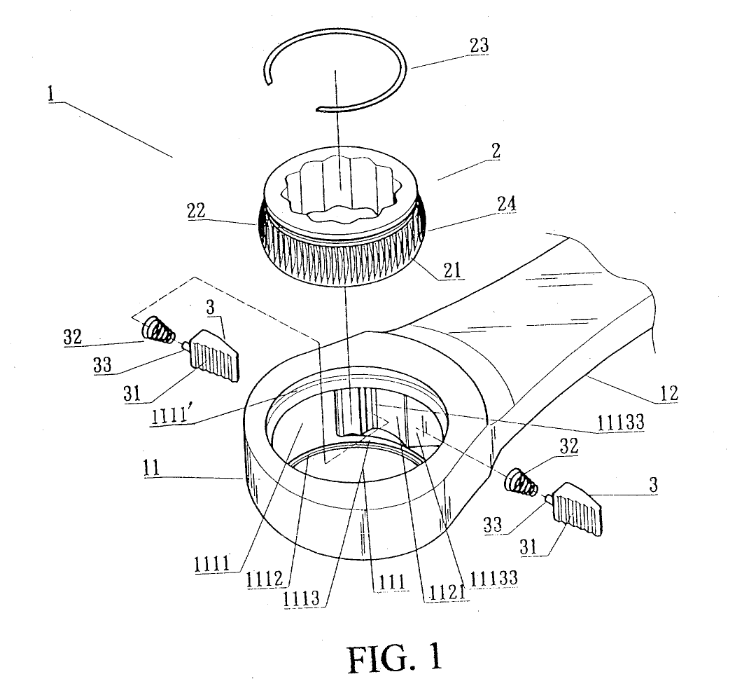

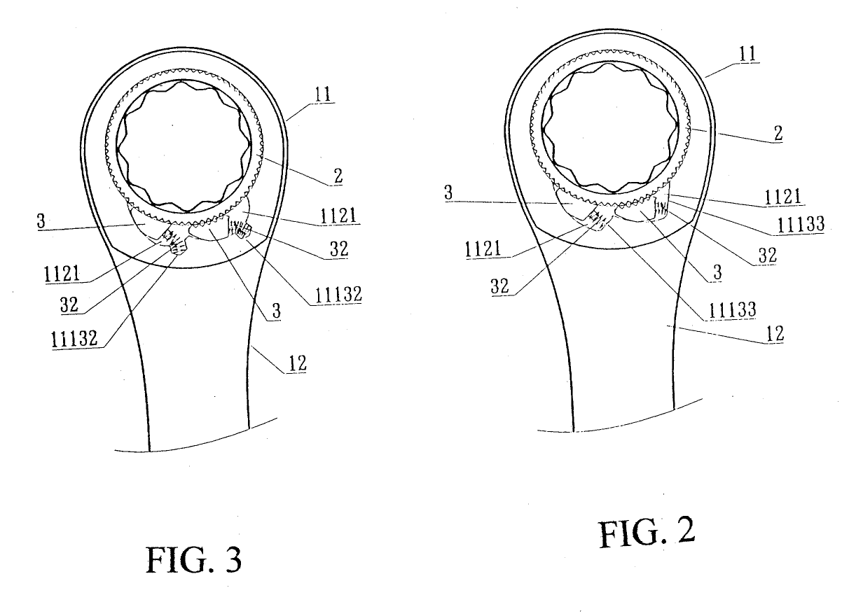

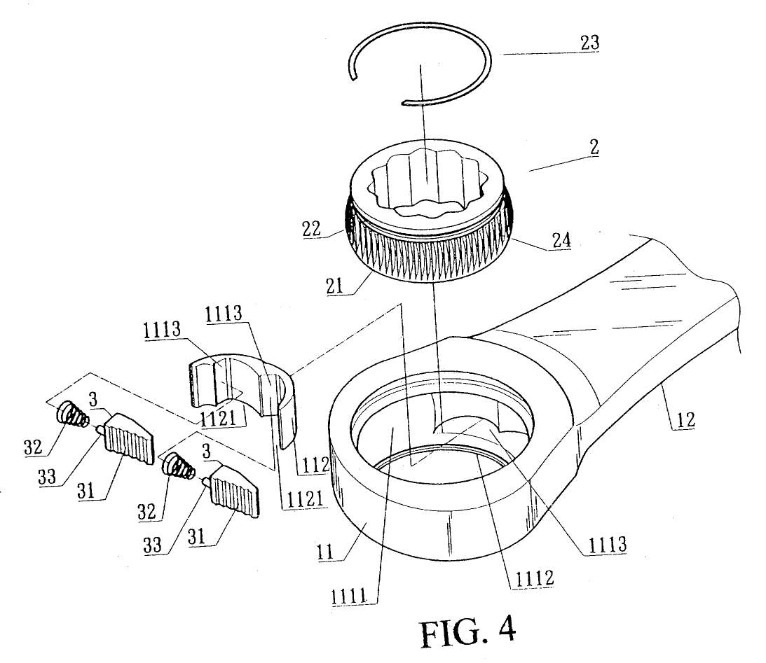

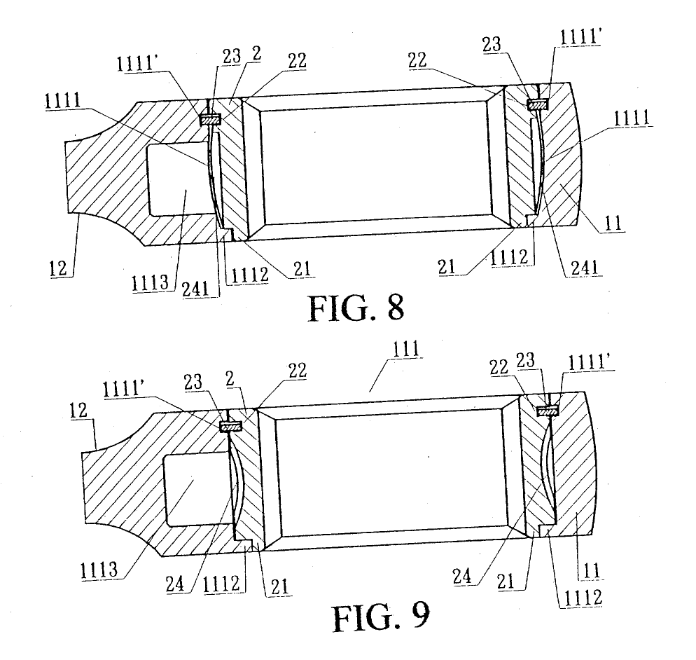

Referring to FIGS. 1 and 2, in the present invention, a ratchet 2 has a ratchet gear 24 which is deposed around a ring portion (or a polygonal member). A spanned base 21 is formed at one end of the ratchet 2. A ratchet base 11 has a ratchet positioning hole 111 for positioning the ratchet gear 24. A circular groove is formed along the inner wall of the ratchet positioning hole 111 such that the ratchet base 11 will not affect the originally design, and can enhance the strength of the ratchet base 11 by increasing the thickness of the ratchet base 11. Furthermore, the wrench is prevented from cracking when the wrench is operated with a large torque. Two grooves 1111 and 1111′ are formed on the inner wall of the ratchet positioning hole 111 of the ratchet base 11 at positions capable of receiving the ratchet gear 24 of the ratchet 2; and an recess 1113 is formed in the inner wall of the ratchet base 11 and hidden inside the gap where the ratchet base 11 and a handle 12 are connected. The recess 1113 has a plurality of cambered concave portions 1121 therein and each cambered concave portion 1121 is designed for receiving at least one mechanical member 3 and one elastic member 32 of the ratchet 2 (will be further described in the following). The curvature of the cambered concave portion 1121 is matched to the curvature of the wall of the recess 1113. Referring to FIG. 3, the cambered concave portion 1121 of the recess 1113 has a desired shape. The elastic member 32 is passed through by a positioning rod 33 on the mechanical member 3 for pressing against a blocking wall 11133 of the recess 1113 or an receiving hole 11132 formed inside the cambered concave portion 1121 for receiving the elastic member 3 in the receiving hole 11132. By pushing the mechanical member 3 along the side of the cambered concave portion 1121 also pushing it along the direction of the circumference of the ratchet 2, the resistance of the mechanical member 3 on the ratchet 2 is reduced in order to have a preferred sensitivity. It does not require that the mechanical member 3 have pivot pins and axial hole formed inside the recess, while the mechanical member 3 can be restricted and positioned inside the cambered concave portion 1121 and is prevented from falling down. Referring to FIGS. 7 and 8, a protruding edge 1112 is protruded from one end of the ratchet base, and has an inner diameter slightly larger than the outer diameter of the ratchet 2. The ratchet 2 has a flat surface ratchet gear 24 or a protruding outward cambered ratchet gear 241 (see FIG. 8), wherein the gear may have a round or polygon shapes. A spanned base 21 is formed at one end of the ratchet 2 and expanding across the protruding rim 1112, and a C ring 23 is placed in a ring groove 22 at another end of the ratchet 2. The ratchet 2 having an outer diameter less than the inner diameter of the positioning hole 111 of the ratchet base 11, and thus the ratchet can be placed into the positioning hole 111 of the ratchet base 11 so that the C ring 23 is arranged in the groove 1111 or an internal rim of the groove 1111′ as shown in FIG. 9. Therefore, the ratchet 2 is prevented from falling off, and thus, the components of the wrench 1 can be installed inside the base 11 to present a preferred outlook. The mechanical gear 31 (also referring to FIG. 4) of each mechanical member 3 is engaged with the ratchet gear 241 of the ratchet 2.

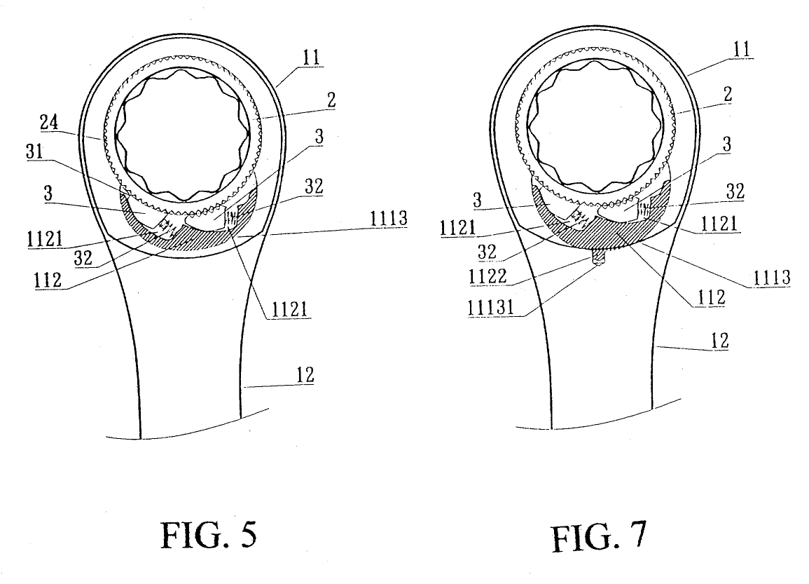

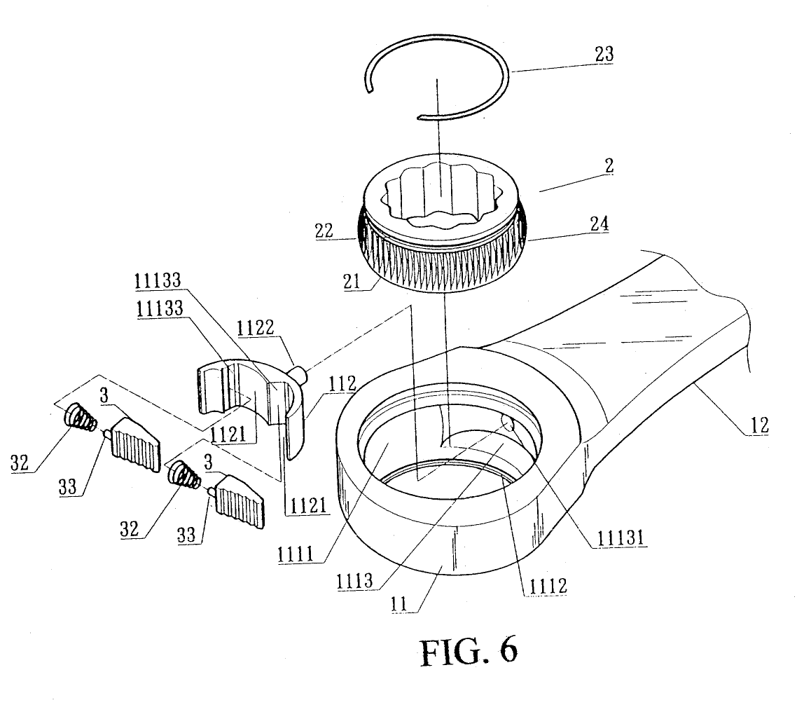

With reference to FIGS. 4 and 5, another embodiment of the present invention is illustrated. The inner wall of the recess 1113 is formed with a predetermined shape and a positioning base 12 is placed in the recess 111. An exterior of the positioning base 112 is manufactured with a shape suitable for the recess 1113 and thus, the positioning base 112 is fixed in the recess 1113. A plurality of cambered concave portions 1121 as those shown in FIG. 1 are formed in the positioning base 112 for receiving the mechanical member 3 and the elastic member 32 such that the mechanical member 3 is directly restricted by the cambered concave portion 1121 and does not need to have pivot pins to restrict the mechanical member. With reference to FIG. 6, the positioning base 112 has a partial-round shape suitable for being engaged with the circular recess 1113. A fixing rod 1122 is installed at the positioning base 112, and a fixing hole 11131 is formed in a wall of the recess 1113. The fixing rod 1122 is inserted into the fixing hole 11131 for preventing the positioning base 112 from displacing. The positioning base 112 is formed integrally. Some cambered concave portions 1121 on the mechanical member can be formed in advance for accommodating a plurality of mechanical members 3 and elastic members 32.

Referring to FIG. 9, the groove 1111′ is identical to above embodiments of an ordinary ratchet base 11. The ratchet of this embodiment presents a non-outwardly cambered shape 2 or a non-outwardly polygon. Moreover, in this embodiment, the recess 1113 and cambered concave portions 1121 are prepared by other ways and operated in connection with the mechanical member 3 and the elastic member 32 while no collar is used.

Therefore, in the present invention, a fact is used, that the curvature of the cambered concave portion is matched to the curvature of the wall of the recess. Thereby, the mechanical member may be pushed to move along the excircle of the ratchet so as to reduce the resistance of the mechanical member. The spanning base of the ratchet is a protruding edge and C ring below the ratchet base is used to restrict the positioning of the ratchet with respect to the ratchet base. The components can be hidden completely inside the ratchet base so as to provide a preferred appearance. In addition, the manufacturing of the ratchet wrench is relatively fast.

The invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

I claim:

10. A ratchet wrench comprising a ratchet and a ratchet base; wherein
said ratchet has a ratchet gear deposed around a ring portion; a spanned base is formed at one end of said ratchet; and
said ratchet base has a ratchet positioning hole for positioning said ratchet gear; two grooves are formed around an inner wall of said ratchet positioning hole of said ratchet base at positions capable of receiving said ratchet gear of said ratchet; and an recess is formed in an inner wall of said ratchet base and hidden inside a gap where said ratchet base and a handle are connected;
characterized in that:
an inner wall of the recess is formed with a predetermined shape and a positioning base is placed in said recess; said positioning base has a shape suitable for being placed in said recess; a plurality of cambered concave portions are formed in said positioning base; each cambered concave portion serves for receiving a mechanical member and an elastic member coupled with said mechanical member such that said mechanical member is directly restricted by said cambered concave portion; a fixing rod is installed at said positioning base at a side without said cambered concave portions, and a fixing hole is formed in a wall of said recess; and said fixing rod is inserted into said fixing hole.
